(19) United States
(12) Patent Application Publication
(10) Pub. No.: US 2006/0047885 A1
(43) Pub. Date: Mar. 2, 2006

(54) Configurable memory module and method for configuring the same

(75) Inventors: Ching-Chen Pan, Taipei (TW); Ying-Cheng Chen, Hsinchu (TW)

Correspondence Address: Howard Chen;Duane Morris LLP, Suite 2000, One Market, Spear Tower, San Francisco, CA, 94105-1104, US

(73) Assignee: Vanguard International Semiconductor Corporation

(21) Appl. No.: 10/927,872

(22) Filed: Aug. 27, 2004

(51) Int. Cl. G06F 12/00

(52) U.S. Cl. 711/5; 711/170

(57) ABSTRACT

A configurable memory module capable of multiple times of use is provided. A string of register bits is used to mark a usage status of the memory segments. The register bits are converted into a sequence of segment identification bits as the most significant bits of a sequence of memory address bits to indicate a physical location of a byte of memory in the memory segment that is currently available for access. A bit value of the register bits is alterable to reflect a change of the usage status, thereby enabling the memory segments to be accessed individually as the memory module is used for multiple times.

### BACKGROUND

The present invention generally relates to a memory module and more particularly to a configurable memory module capable of being divided into memory segments for multiple usages.

Memory modules are broadly categorized into volatile memory and nonvolatile memory. Volatile memory preserves data only when it is supplied with electric power. Nonvolatile memory is able to preserve data indefinitely, even when it is not connected to any power source. One common characteristic of a volatile memory module or a non-volatile memory module is that its memory space has to be used as an undivided unit. This restricts the memory module's flexibility in terms of accommodating various usage. For example, a software program having a code size of 32 KB is stored in a 64 KB Read Only Memory (ROM) circuit. Conventionally, while the software program occupies a 32 KB memory space, the unused 32 KB memory space cannot be concurrently utilized by other programs. If another software program needs to be programmed into the ROM circuit, the early stored software program must be erased first. Such data erasure can be performed only in certain types of ROM, such as EPROM, EEPROM and flash memory. In any event, the processes for the data erasure is troublesome and time-consuming.

The memory space unoccupied by an early stored program in a non-erasable ROM circuit can never be used and will always be a waste of resource. For example, an One Time Programmable (OTP) memory module, a type of non-erasable ROM circuit, is particularly susceptible to this kind of waste problem. To be specific, a packaged OTP memory module that is often seen in the market is really an EPROM circuit enclosed in plastic packaging that blocks ultraviolet light source. Thus, once data are written into the OTP memory module, they cannot be erased by means, such as ultraviolet radiation. If the OTP memory module is not programmed correctly, the whole chip must be disposed. This is true even though there is only ten percent of the memory space is incorrectly programmed and the remaining ninety percent is unused.

What is needed is a memory module that can be configured into a plurality of memory segments for multiple usages.

### SUMMARY

The invention presents a method for configuring a memory module into memory segments for multiple times of use. A string of register bits is used to mark a usage status of the memory segments. The register bits are converted into a sequence of segment identification bits to indicate which memory segment is currently available for access. The segment identification bits are designated as leading bits of a sequence of memory address bits so that the memory address bits are able to indicate a physical location of a byte of memory in the memory segment that is currently available for access. A bit value of the register bits is alterable to reflect a change of the usage status, thereby enabling the memory segments to be accessed individually as the memory module is used for multiple times.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates a configurable memory module that can be divided into several memory segments for multiple usages, according to one embodiment of the present invention.

### DESCRIPTION

The present invention describes a configurable memory module that can be divided into memory segments for multiple usages. A configuration register is used to contain a configuration value representing the number of the memory segments that the configurable memory module is artificially divided into. A map register includes a string of register bits indicating which memory segment is currently available for accessing. The register bits are converted into segment identification bits that will be assigned as the most significant bits of a sequence of address bits. The segment identification bits point the sequence of address bits to the memory segment that is currently available for accessing. The rest of the address bits have sufficient bits to fully indicate the physical locations of all the bytes of memory in this particular memory segment. When this particular memory segment is no longer suitable for use, the value of the register bits will be changed and a new memory segment will be indicated for current accessing and programming. As such, the memory segments may function as independent memory units that can be used individually and separately.

The present invention may be applied in all kinds of volatile and non-volatile memory module including, but not limited to, SRAM, DRAM, EPROM, EEPROM, OTP ROM and flash memory. For illustration purposes, the invention is described based on an OTP memory module as the follows.

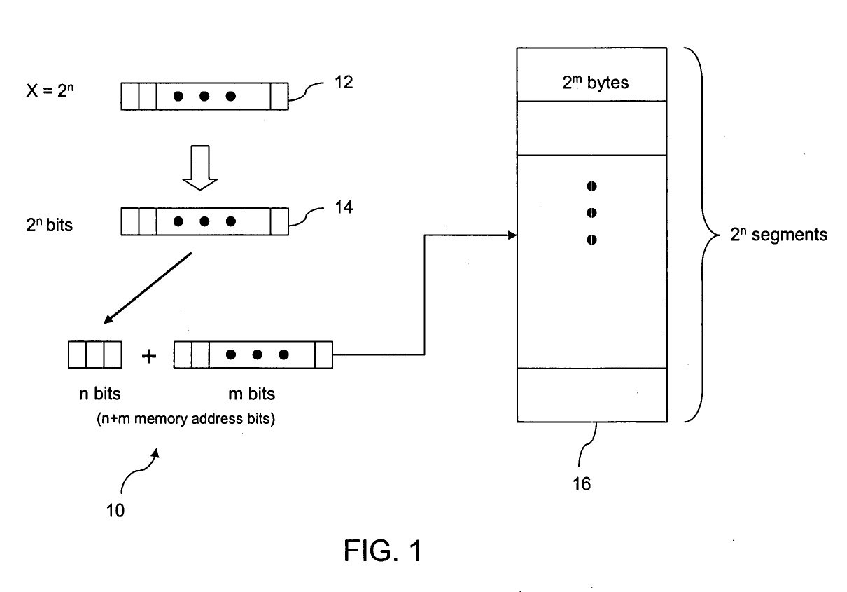

FIG. 1 illustrates a configurable OTP memory module 10 according to one embodiment of the present invention. A configuration register 12 has a configuration value X representing the number of memory segments that the OTP memory module is artificially divided into. It is preferred that the value X equals to 2ⁿ wherein n is an integer, so that X is 2, 4, 8 . . . or the like number. For example, if n equals to 3, the OTP memory module 10 will be configured into eight equal memory segments 16 for data storage. Because the total memory capacity of the OTP memory module 10 can be expressed in a two based exponential number that cannot be smaller than 2ⁿ, it can be described as 2^{(n+m)} bytes. Since the OTP memory module 10 is configured into 2ⁿ memory segments, each one has the memory capacity of 2^{m} bytes. For example, if a 64 (2⁶) bytes OTP memory module is configured into 8 (2³) segments, the total memory capacity can be expressed as 2³⁺³ and each memory segment will have the size of 8 (2³) bytes.

A memory address for one memory byte in the 2^{(n+m)} bytes OTP memory module 10 requires at least n+m address bits. The most significant n bits indicate a particular memory segment, and the least significant m bits indicate a particular byte in that indicated memory segment. For example, a 64 KB OTP memory module divided into 8 memory segments can be expressed as 2⁽³⁺¹³⁾ bytes. Thus, a memory address requires 16 bits, wherein the first 3 bits indicate a particular memory segment and the following 13 bits indicate a particular byte in that memory segment.

In this embodiment, the map register 14 has at least 2ⁿ register bits for indicating which memory segment is currently available for accessing. While the map register 14 may include more than 2ⁿ bits, only the last 2ⁿ bits are useful in indicating the memory segments and the rest of bits have no significance. Each register bit indicates a usage status of a corresponding memory segment. For example, if the register bit is “1,” it means that the corresponding memory segment is currently accessible for programming or data retrieving. If the bit is “0,” it means the corresponding memory segment is not available for current use. Note that as an alternative, the register bits may indicate the usage status of the memory segments in a collective, instead of individual, manner. In such case, a smaller number of register bits may be used to indicate the usage status of a greater number of memory segments.

The default of the register bits may be set as a sequence of “1s.” This means that all of the memory segments are useable and the first memory segment is currently available for accessing. When the first memory segment is no longer desired or suitable for use, the last register bit will be changed from “1” to “0” and any new code will be programmed into the second memory segment. In a likewise manner, when the second memory segment is no longer desired or suitable for use, the second least significant register bit will be changed to “0,” meaning that the third segment is marked as currently available for access.

Note, as an alternative, the discarded memory segments can also be marked by changing the corresponding register bit from “0” to “1.” In such case, the default of register bits would be a sequence of “0s.” Furthermore, in this embodiment, once a register bit is changed from “1” to “0,” it can never be changed back. This is because an OTP memory module cannot be reprogrammed. Note if the invention is applied to configure other types of reprogrammable memory modules, such as EPROM, EEPROM, flash memory, DRAM and SRAM, into many memory segments, it would be possible that register bit may be changed back from “0” to “1.”

It is understood that the various designs of circuits can be used to achieve the above described configuration logic. For example, a converting circuit can be provided to convert the register bits into the segment identification bits. The converting circuit is connected to an address bus in such a way that the segment identification bits will always be the most significant bits of any address bits for a byte of memory. As discussed above, the n-bit segment identification bits indicates a particular memory segment, and the rest of the address bits indicates the physical location of a particular byte of memory in that memory segment.

The present invention is particularly advantageous when applying to an OTP memory module. The configured memory segments enable the OTP memory module to be reused for multiple times. This allows an end user to reprogram the OTP memory module, when he has made several failed attempts to some of the memory segments or when he simply wants to discard earlier used segments and program new applications codes into another memory segment. This would greatly enhance the OPT memory module's flexibility of usage.

The following illustrate an example of the above described embodiment. A 64 KB OTP memory module is configured into eight 8 KB memory segments. Since 64 KB equals to 2¹⁶ bytes, a memory address requires at least 16 address bits wherein 3 leading address bits identify the memory segments and the following 13 address bits identify a particular byte of memory in the identified memory segment. The first segment identification bits are “000” followed by 13 address bits from 0X0000 to 0X1FFF. The second segment identification bits are “001” followed by 13 address bits from 0X2000 to 0X3FFF. Table 1 shows the address bits for the entire 8 memory segments.

TABLE 1

| Segment | Segment Identification Bits | Address Bits |
|---|---|---|
| 1 | 000 | 0X0000˜0X1FFF |
| 2 | 001 | 0X2000˜0X3FFF |
| 3 | 010 | 0X4000˜0X5FFF |
| 4 | 011 | 0X6000˜0X7FFF |
| 5 | 100 | 0X8000˜0X9FFF |
| 6 | 101 | 0XA000˜0XBFFF |
| 7 | 110 | 0XC000˜0XDFFF |
| 8 | 111 | 0XE000˜0XFFFF |

Since the OTP memory module is configured into 8 memory segments, the map register requires at least 8 register bits. The register bits “11111111” means that all of the 8 memory segments are useable and the first memory segment is currently available for accessing and programming. Once the first segment is discarded, the last register bit will be changed from “1” into “0” to indicate that the first segment is no longer useable and the second memory segment is now currently available for use. When the second memory segment is discarded, the second register bit from the end will be changed from “1” to “0.” In a like manner, one more discarded memory segment one more register bit is changed from “1” to “0,” as shown in table 2. In fact, the number of “0s” represents the number of discarded memory segments.

TABLE 2

| Discarded Segment | Register Bits | Segment Identification Bits |
|---|---|---|
| 0 | 11111111 | 000 |
| 1 | 11111110 | 001 |
| 2 | 11111100 | 010 |
| 3 | 11111000 | 011 |
| 4 | 11110000 | 100 |
| 5 | 11100000 | 101 |
| 6 | 11000000 | 110 |
| 7 | 10000000 | 111 |

Note that the above example is for purposes of illustration. It is not imperative that values of the register bits are changed from “1” to “0” in a sequential manner. Which register bit is selected for a value change can be done in a non-sequential way, as long as the register bits are able to unequivocally identify the segment identification bits.

As discussed above, a converting circuit can be provided to convert the register bits into the segment identification bits. For example, the register bits “11111111” are converted into segment identification bits “000.” The 3-bit segment identification bits will lead any address bits to indicate the memory segment currently available for access The rest of the register bits converted into the segment identification bits are shown in table 2.

The above invention provides many different embodiments, or examples, for implementing different features of the invention. Specific examples of components, and processes are described to help clarify the invention. These are, of course, merely examples and are not intended to limit the invention from that described in the claims.

Although illustrative embodiments of the invention have been shown and described, other modifications, changes, and substitutions are intended in the foregoing invention. Accordingly, it is appropriate that the appended claims be construed broadly and in a manner consistent with the scope of the invention, as set forth in the following claims.

What is claimed is:

1. A method for configuring a memory module into a plurality of memory segments for multiple times of use, the method comprising:
configuring the memory module into a number of the memory segments;
marking a usage status of the memory segments with a string of register bits;
converting the register bits into a sequence of segment identification bits to indicate which memory segment is currently available for access; and
designating the segment identification bits as leading bits of a sequence of memory address bits so that the memory address bits are able to indicate a physical location of a byte of memory in the memory segment that is currently available for access,
wherein a bit value of the register bits is alterable to reflect a change of the usage status, thereby enabling the memory segments to be accessed individually as the memory module is used for multiple times.

2. The method of claim 1 wherein the configuring includes determining a configuration value representing a predetermined number of the memory segments into which the memory module is divided.

3. The method of claim 2 wherein the configuration value is expressed in a form of 2ⁿ where n is an integer.

4. The method of claim 3 wherein the register bits have at least 2ⁿ bits and each bit value of the 2ⁿ register bits individually represents the usage status of the corresponding memory segment.

5. The method of claim 3 wherein the register bits have fewer than 2ⁿ bits and all of the bit values of the 2ⁿ register bits collectively represent the usage status of the corresponding memory segment.

6. The method of claim 4 wherein each of the register bits has a first bit value representing that the corresponding memory segment is usable and a second bit value representing that the corresponding memory segment is not usable.

7. The method of claim 6 wherein the bit value of the register bits is changed from the first bit value to the second bit value, irrevocably.

8. The method of claim 6 wherein the bit values of the register bits is changed in a sequential order.

9. The method of claim 1 wherein the memory module is an OTP memory module.

10. A configurable memory module comprising:
a plurality of memory segments;
a map register having a string of register bits representing a usage status of the memory segments;
a converting circuit for converting the register bits into a sequence of segment identification bits as leading bits of a sequence of address bits to indicate a physical location of a byte of memory in the memory segment that is marked as currently available for access based on the usage status,
wherein a bit value of the register bits is alterable to reflect a change of the usage status, thereby enabling the memory segments to be accessed individually as the memory module is used for multiple times.

11. The module of claim 10 further comprising a configuration register having a configuration value representing a number of the memory segments into which the memory module is divided.

12. The module of claim 11 wherein the configuration value is expressed in a form of 2ⁿ where n is an integer.

13. The module of claim 12 wherein the register bits have at least 2ⁿ bits and each bit value of the 2ⁿ register bits individually represents the usage status of the corresponding memory segment.

14. The module of claim 12 wherein the register bits have fewer than 2ⁿ bits and all of the bit values of the 2ⁿ register bits collectively represent the usage status of the corresponding memory segment.

15. The module of claim 13 wherein each of the register bits has a first bit value representing that the corresponding memory segment is usable and a second bit value representing that the corresponding memory segment is not usable.

16. The module of claim 15 wherein the bit value of the register bits is changed from the first bit value to the second bit value, irrevocably.

17. The module of claim 15 wherein the bit values of the register bits is changed in a sequential order.

18. The module of claim 10 wherein the memory module is an OTP memory module.

19. The module of claim 10 wherein the converting circuit is connected to leading lines of an address bus of the memory module, such that placing the segment identification bits as the leading bits of the memory address bits.

20. An OTP memory module capable of being configured into a plurality of memory segments for multiple times of use, the OTP memory module comprises:
a plurality of memory segments;
a configuration register having a configuration value representing a number of the memory segments into which the OTP memory module is configured;
a map register having a string of register bits representing a usage status of the memory segments;
a converting circuit for converting the register bits into a sequence of segment identification bits as leading bits of a sequence of address bits to indicate a physical location of a byte of memory in the memory segment that is marked as currently available for access based on the usage status,
wherein a bit value of the register bits is alterable to reflect a change of the usage status, thereby enabling the memory segments to be accessed individually as the OTP memory module is used for multiple times.

21. The OTP memory module of claim 20 wherein the configuration value is expressed in a form of 2ⁿ where n is an integer.

22. The OTP memory module of claim 21 wherein the register bits have at least 2ⁿ bits.

23. The OTP memory module of claim 22 wherein each of the register bits has a first bit value representing that the corresponding memory segment is usable and a second bit value representing that the corresponding memory segment is not usable.

24. The OTP memory module of claim 20 wherein the converting circuit is connected to leading lines of an address bus of the memory module, such that placing the segment identification bits as the leading bits of the address bits.
